(19) United States
(12) Patent Application Publication
(10) Pub. No.: US 2024/0400316 A1
(43) Pub. Date: Dec. 5, 2024

(54) SYSTEM FOR CARRYING OUT WORK PROCESSES ON WORKPIECES OR THE LIKE

(71) Applicant: Robert Bosch GmbH, Stuttgart (DE)

(72) Inventor: Sami Touhent, Moessingen (DE)

(21) Appl. No.: 18/698,157

(22) PCT Filed: Oct. 10, 2022
(86) PCT No.: PCT/EP2022/078125

§ 371 Date: Apr. 3, 2024

(30) Foreign Application Priority Data
Oct. 11, 2021 (DE) 10 2021 211 428.8

(51) Int. Cl. B65G 47/53

(52) U.S. Cl. CPC B65G 47/53

(57) ABSTRACT

A system for carrying out work processes on workpieces or the like. The system includes a work surface on which are arranged first transport units which are movable independently of one another by electromagnetic drives and are designed to remove the workpieces or the like from a first conveying device, subsequently to feed them to process stations for carrying out the work processes on the workpieces or the like, and finally to transfer the workpieces or the like to a second conveying device.

### FIELD

The present invention relates to a system for carrying out work processes on workpieces or the like, in which the system is designed to carry out secondary processes in a particularly advantageous manner in addition to the work processes.

### BACKGROUND INFORMATION

In U.S. Patent Application Publication No. US 2012/0213614 A1, it is described to arrange, on a work surface, handling devices which are movable independently of one another and are moved by means of electromagnetic drives. The handling devices serve to feed workpieces or the like to chambers in which work processes are performed.

Furthermore, U.S. Patent Application Publication No. US 2004/0173284 A1 describes arranging calibration stations next to a conveying section for bottles to be filled, wherein the filling needles, which are arranged, for filling the bottles, in the region of a conveying device, can be moved into the region of the calibration stations.

### SUMMARY

A system according to the present invention for carrying out work processes on workpieces or the like may have the advantage that, in a particularly advantageous manner, the system makes it possible to realize secondary processes, which are required at the same time as or a different time to the work processes in order to ensure the quality of the work processes in that the process stations participating in the work processes are checked with regard to their correct function.

The present invention is based on the idea of providing not only transport units which serve exclusively for feeding or transporting objects or the like to the process stations for carrying out the work processes, but also additional transport units which serve exclusively for transporting devices for carrying out secondary processes either in parallel with the work processes or before or after the operation of the system.

Against the background of the above explanations, it is therefore provided in a system according to an example embodiment of the present invention for carrying out work processes on workpieces or the like that a work surface is present, on which are arranged first transport units which are movable independently of one another by electromagnetic drives and are designed to remove the workpieces or the like from a first conveying device, subsequently to feed them to process stations for carrying out work processes on the workpieces or the like, and finally to transfer the workpieces or the like to a second conveying device. Furthermore, the system according to the present invention comprises at least one second, electromagnetically movable transport unit which is designed to transport a device or similar elements for carrying out a process, coordinated with the work processes, on the work surface to at least one process station.

Advantageous developments of the system according to the present invention for carrying out work processes on workpieces or the like are disclosed herein.

An example embodiment of the at least one second transport unit of the present invention in which the second transport unit is designed to transport different devices or similar for carrying out coordinated processes is particularly preferred.

In a preferred development of such a second transport unit according to the present invention, it is provided that the at least one second transport unit has a holding device with at least one standardized interface for the different devices or similar. Such a standardized interface can, for example, form a positive connection or a clamped connection in order to position the relevant device or similar securely in the region of the at least one second transport unit and to ensure safe transport to the relevant process station.

According to an example embodiment of the present invention, it is also particularly preferred if the at least one device or similar for carrying out the process coordinated with the work processes is arranged in a region next to the work surface.

There are also different possibilities with regard to the arrangement of the at least one second transport unit. According to an example embodiment of the present invention, it is preferred that the at least one second transport unit is arranged in a provision zone in the region of the work surface. Such a provision zone can be provided, for example, in an edge region of the work surface so that common transport paths of the first transport units there are not impaired.

Furthermore, according to an example embodiment of the present invention, it is preferably provided that the first transport units are designed to execute first conveying paths that are different from the conveying paths of the at least one second transport unit. However, it can certainly be provided that the conveying paths of the first transport units and of the at least one second transport unit cross.

In a preferred embodiment of the system of the present invention, it is furthermore provided that the process stations include at least one dispensing station for dispensing an in particular pasty medium to the workpiece or the like.

According to an example embodiment of the present invention, the device for carrying out a process coordinated with the work processes is in particular designed in the form of a calibration device or a test device. Such devices are typically characterized in that they are required at the individual process stations, for example before the system is put into operation, after the operation of the system has ended, or else in each case after a particular number of work processes has been carried out.

A further preferred example embodiment of the at least one second transport unit of the present invention provides that the second transport unit is producible by fitting a first transport unit with a conversion kit. This makes it possible to use standardized transport units which can be converted alternately or as needed to form first transport units or second transport units.

Further advantages, features and details of the present invention result from the following description of preferred exemplary embodiments and with reference to the figures.

### BRIEF DESCRIPTION OF THE DRAWINGS

FIG. 1 is a simplified representation of an apparatus for carrying out work processes on workpieces or the like, according to an example embodiment of the present invention.

FIG. 2 is a side view of the apparatus in the region of a provision zone for devices for carrying out different coordinated processes, according to an example embodiment of the present invention.

### DETAILED DESCRIPTION OF EXAMPLE EMBODIMENTS

Identical elements or elements which have the same function are provided with the same reference signs in the drawings.

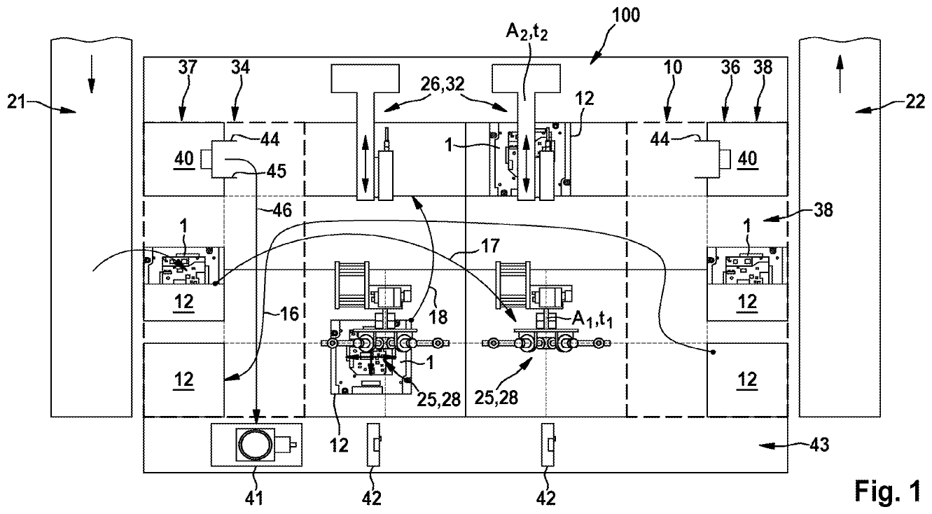

FIG. 1 is a highly simplified view of a system 100 for carrying out work processes on workpieces 1 or the like. The workpieces 1 may, for example, be housing parts or similar, which are to be provided by means of the system 100 in a local or defined region with a pasty medium for sealing the housing parts.

The system 100 comprises a work surface 10 which is arranged horizontally, wherein a plurality of first transport units 12, so-called movers, are located on the work surface 10. The first transport units 12 are controllable individually by a control device (not shown in the drawings), wherein the first transport units 12 are arranged so as to be freely movable on the work surface 10. For this purpose, electromagnetic drives (not shown) are specifically used, which allow the first transport units 12 to execute any first conveying paths 16 to 18.

By way of example, the first transport units 12 serve to each transport a workpiece 1 or the like in the region of the work surface 10. The workpieces 1 or the like are fed to the system 100 laterally of the work surface 10 by means of a first conveying device 21, which is only shown symbolically and is preferably designed in the form of a linear conveyor, such as a chain conveyor, a belt conveyor or similar. After carrying out work processes in the region of the system 100, the (processed) workpieces 1 or the like are transported away from the region of the work surface 10 or of the system 100 by means of a second conveying device 22, which is arranged on the side of the work surface 10 opposite the first conveying device 21 and is likewise only shown symbolically. The second conveying device 22 is preferably also designed in the form of a linear conveyor.

By means of gripping devices or similar devices (not shown), the workpieces 1 or the like can be removed from the first conveying device 21 and placed on the first transport units 12. Likewise, after the work processes have been carried out, the gripping devices or similar (not shown) serve to lift the workpieces 1 or the like from the first transport units 12 and to feed them to the second conveying device 22.

For carrying out the work processes by means of the system 100, said system has, by way of example, two first process stations 25 and two second process stations 26 in the region of and, optionally, above the work surface 10. The first process stations 25, which are arranged laterally next to one another, are designed as dispensing stations 28 each having at least one dosing device in the form of a dosing needle or similar element that is liftable as well as movable in the plane of the work surface 10. The second process stations 26 are, for example, test devices 32 in the form of cameras or similar devices, which serve to monitor the work processes carried out by the first process stations 25 or to check them for proper execution.

The work surface 10 has, in each case laterally next to the process stations 25 and 26, a first and a second provision zone 34, 36, each marked with a dashed border, in the region of which first transport units 12 can be arranged. Furthermore, the provision zones 34 and 36, which are rectangular by way of example, serve, in particular in the region of waiting zones 37, 38, to receive at least one second transport unit 40 or to park it there.

While the first transport units 12 serve to feed the workpieces 1 or the like to the process stations 25, 26 so that so-called main processes (referred to above as work processes) can run there, the second transport units 40 serve to be able to carry out secondary processes that are independent of the main processes in terms of time and/or location. The secondary processes include, for example, the calibration or the checking of the functional capability of the process stations 25, 26 by means of calibration devices 41 or test devices 42. The calibration devices 41 and test devices 42 are arranged, by way of example, in a strip-shaped region 43 next to the work surface 10.

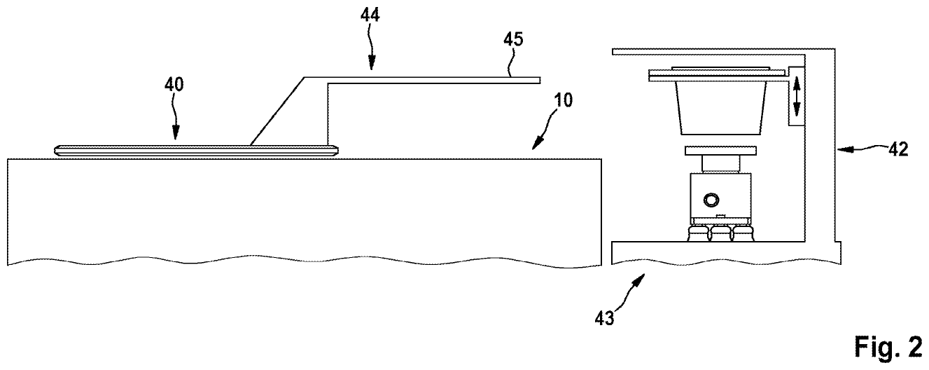

As can be seen in FIG. 2, on its upper side, the second transport unit 40, which is controllable by the control device by means of an electromagnetic drive and which is freely movable on the work surface 10, has a gallows-shaped holding device 44, which serves to receive, position and hold a calibration device 41 or a test device 42 or an element of the calibration device 41 or a test device 42 in the region of the second transport unit 40 by means of a standardized interface 45, for example for forming a positive connection by means of an opening or similar. In particular, the holding device 44 can be designed in the form of a conversion kit so that first transport units 12 can also be converted or modified in a simple manner into second transport units 40.

With regard to FIG. 1, the principle of operation of the system 100 is explained as follows: For example, before the system 100 is put into operation or before the main processes or work processes are carried out by means of the process stations 25, 26, it is necessary to calibrate or test the process stations 25, 26. For this purpose, a second transport unit 40 is moved, for example from the provision zone 34, 36, in the direction of the region 43 in order to take over a calibration device 41 or a test device 42. This is shown in FIG. 1 by way of example on the basis of a second conveying path 46, which may optionally also cross one of the first conveying paths 16 to 18. Subsequently, the calibration device 41 or a test device 42 or an element of the mentioned devices is transported by means of the second transport unit 40 into the region of the process station 25, 26 to be checked, in order to perform a corresponding calibration or test of the process station 25, 26 there. As soon as this has taken place, the second transport unit 40 conveys the calibration device 41 or a test device 42 or the corresponding element back to its position provided for this purpose in the region 43.

Subsequently, the operation of the system 100 is started by taking over workpieces 1 or the like by means of the first transport units 12 and feeding the workpieces 1 or the like to the individual process stations 25, 26. After the work processes have been carried out, the workpieces 1 or the like are transported away from the region of the system 100 via the second conveying device 22.

It may furthermore be provided that a check or calibration of a process station 25, 26 must also be performed, for example, after a certain number of work processes, for example after every 100 doses of medium at a dispensing station 28. For this purpose, it is optionally not necessary to interrupt the work process of the system 100; rather, the check can also take place during the filling operation in that the control device exclusively controls a second dispensing device 28 with the corresponding workpieces 1 or the like while a first process station 25 (dispensing device 28) is being checked, for example.

The unit 100 described thus far can be altered or modified in many ways without deviating from the scope of the present invention.

1-10. (canceled)

11. A system for carrying out work processes on workpieces, comprising:
a work surface on which are arranged first transport units which are movable independently of one another by electromagnetic drives and are configured to remove the workpieces from a first conveying device, to subsequently feed the workpieces to process stations for carrying out the work processes on the workpieces, and to transfer the workpieces to a second conveying device; and
at least one second electromagnetically movable transport unit which is configured to transport a device for carrying out a process, coordinated with the work processes, on the work surface to at least one process station.

12. The system according to claim 11, wherein the at least one second transport unit is configured to transport different devices for carrying out coordinated processes.

13. The system according to claim 12, wherein the at least one second transport device has a holding device including at least one standardized interface for the different devices.

14. The system according to claim 11, wherein the device for carrying out the process coordinated with the work processes is arranged in a region next to the work surface.

15. The system according to claim 11, wherein the at least one second transport unit is arranged in a provision zone in a region of the work surface.

16. The system according to claim 11, wherein the first transport units are configured to execute first conveying paths which are different from second conveying paths of the at least one second transport unit.

17. The system according to claim 16, wherein the first and second conveying paths of the first and the second transport units cross.

18. The system according to claim 11, wherein the process stations include at least one dispensing station configured to dispense a pasty medium to the workpiece.

19. The system according to claim 11, wherein the device for carrying out the process coordinated with the work processes is a calibration device or a test device.

20. The system according to claim 11, the at least one second transport unit is formed by fitting a first transport unit with a conversion kit.
